(19) United States
(12) Patent Application Publication
(10) Pub. No.: US 2009/0066139 A1
(43) Pub. Date: Mar. 12, 2009

(54) VEHICLE SEAT WITH TWO PIVOTABLE BACKRESTS

(76) Inventors: Jens Schulz, Kaiserslautern (DE); Andreas Diehl, Otterbach (DE)

Correspondence Address: MCGLEW & TUTTLE, PC, P.O. BOX 9227, SCARBOROUGH STATION, SCARBOROUGH, NY, 10510-9227, US

(21) Appl. No.: 11/718,462

(22) PCT Filed: Feb. 1, 2006
(86) PCT No.: PCT/EP2006/000835

§ 371 Date: May 2, 2007

(30) Foreign Application Priority Data
Mar. 1, 2005 (DE) 10 2005 009 126.1

(51) Int. Cl. B60N 2/20

(52) U.S. Cl. 297/378.1

(57) ABSTRACT

The invention relates to a vehicle seat, in particular a motor vehicle seat, comprising at least one first seat-back (3) and one second seat-back (5), which can be pivoted, respectively, from an operating position into a non-operating position, and comprising a locking device (11) which locks the two seat-backs (3, 5) together in the operating position. Said locking device (11) comprises two connecting elements (19) which are connected by means of a joint (17) from which each element is locked by an associated seat-back, when the second seat-back (5) is locked the first seat-back (3) is pivoted and when the first seat-back (3) is locked the second seat-back (5) is pivoted. In order to pivot only one of the two seat-backs (3, 5), one of the connecting elements (19), which is associated with the seat-back which is to be pivoted (3, 5), is unlocked and is pivoted towards the other connecting device in a tilted position.

### CROSS REFERENCE TO RELATED APPLICATIONS

This application is a United States National Phase application of International Application PCT/EP2006/000835 and claims the benefit of priority under 35 U.S.C. § 119 of German Patent Application DE 10 2005 009 126.1 filed Mar. 1, 2005, the entire contents of which are incorporated herein by reference.

### FIELD OF THE INVENTION

The invention relates to a vehicle seat, in particular a motor vehicle having at least one first backrest and a second backrest, each of which can be pivoted from an in-use position into a non-use position, and having a locking mechanism.

### BACKGROUND OF THE INVENTION

In known vehicle seats of this type, as described for example in DE 197 01 775 C2, the locking mechanism between the backrests comprises an axially slidable bolt which is mounted and actuated on one of the backrests and interacts with a suitable receiving part on the other backrest. The unlocking action is thus assigned to the backrest on which the bolt is mounted, as a result of which there is a certain amount of asymmetry involved in the unlocking process.

### SUMMARY OF THE INVENTION

The object of the invention is to improve a vehicle seat of the above-mentioned type.

According to the invention, a vehicle seat, in particular a motor vehicle seat, is provided having at least one first backrest and a second backrest. Each backrest can be pivoted from an in-use position into a non-use position. The vehicle seat has a locking mechanism that locks the two backrests together with each other in the in-use position. The locking mechanism comprises at least one connecting element that is locked with the second backrest when the first backrest is pivoted, and that is locked with the first backrest when the second backrest is pivoted.

Because the locking mechanism comprises at least one connecting element which, when the first backrest is pivoted, is locked with the second backrest and which, when the second backrest is pivoted, is locked with the first backrest, symmetrical conditions exist for both backrests, so that each of the backrests can be pivoted separately—without observing a certain unlocking sequence—while the respective other backrest can remain unpivoted. The single connecting element is thus locked with the unpivoted second backrest when only the first backrest is pivoted, and is locked with the unpivoted first backrest when only the second backrest is pivoted. It goes without saying that the solution according to the invention also embodies the possibility that both backrests may be pivoted.

In addition, unlocking may be carried out from both sides of the vehicle. Compared with vehicle seats having two unconnected backrests, the safety in a crash is increased, because the barn-door effect is avoided that is produced when, in the event of a crash, the cargo forces open and penetrates through the gap between the backrests. The invention may also be expanded to include vehicle seats with more than two backrests. Each of both backrests preferably comprises a recess for the connecting element on mutually facing sides. These recesses serve to accommodate the connecting element as well as to arrange the locking elements.

In order to achieve a nearly symmetrical structure of the locking mechanism, i.e. in order to bring the plane of separation of the backrests into alignment with the plane of separation of the locking mechanism, preferably two connecting elements are provided which are joined with each other in such a way that they are movable relative to each other, for example being articulatedly connected with each other by means of a joint, or coupled by a spring. Each of the connecting elements is assigned to one of the backrests and is detachably locked with the latter. In the in-use position preferably each of the two connecting elements cooperates and makes positive engagement with the structure of the backrest assigned to it, the backrest structure defining the boundaries of the recess. In addition, preferably each of the two connecting elements is also locked, in each case, by means of one locking element, with the structure of the backrest assigned to it, whereby the two backrests are locked with each other. The locking elements are movably mounted on the structure of the assigned backrest and may be moved in a pivoting or linear or other manner. Each of the locking elements is assigned an unlocking means which must be actuated in order to permit the assigned backrest to be pivoted, while the respective other unlocking means, which is independent of it, remains unactuated. If both locking elements were unlocked, the connecting elements would be loosely arranged in the recesses.

In the in-use position, the two connecting elements preferably assume an extended configuration in relation to each other, so that they project to the maximum extent into the two recesses and thus provide the best possible safety in the event of a crash. In order to pivot a backrest, the connecting element assigned to the backrest to be pivoted is unlocked and preferably swiveled towards the other connecting element, so that it does not impede the pivoting of the backrest. In the process, the connecting elements preferably assume a bent configuration relative to each other. This bent configuration is preferably secured by means of a detent mechanism that is opened again by exerting pressure on one of the connecting elements. The bent configuration is also preferably set up in such a manner that in the non-use position the connecting element that is for the most part swiveled into the recess of the unpivoted backrest still projects partially into the pivoting path of the pivoted backrest, so that when the backrest is pivoted back into position, the connecting element comes into contact with same, thereby causing the swiveled connecting element to swivel outwards again and thus bring about automatic locking.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of the exemplary embodiment;

FIG. 2 is a merely partially depicted, horizontal cross-sectional view through the two backrests of the exemplary embodiment in the in-use position;

FIG. 3 is a cross-sectional view taken along the line III-III in FIG. 2, with the unlocked connecting element being depicted by a dashed outline;

FIG. 4 is a cross-sectional view corresponding to FIG. 2 after unlocking;

FIG. 5 is a cross-sectional view corresponding to FIGS. 2 and 4 when the first backrest is pivoted forwards;

FIG. 6 is a cross-sectional view corresponding to FIGS. 2, 4 and 5 with the first backrest pivoted forwards into the non-use position;

FIG. 7 is a partial view of the connecting elements in the extended configuration;

FIG. 8 is a partial view of the connecting elements in the bent configuration;

FIG. 9 is a detailed view of the detent mechanism after the lug has entered the guide;

FIG. 10 is a detailed view corresponding to FIG. 9, showing the lug engaged in the detent; and

FIG. 11 is a detailed view corresponding to FIG. 10, showing the outward movement of the lug in the guide.

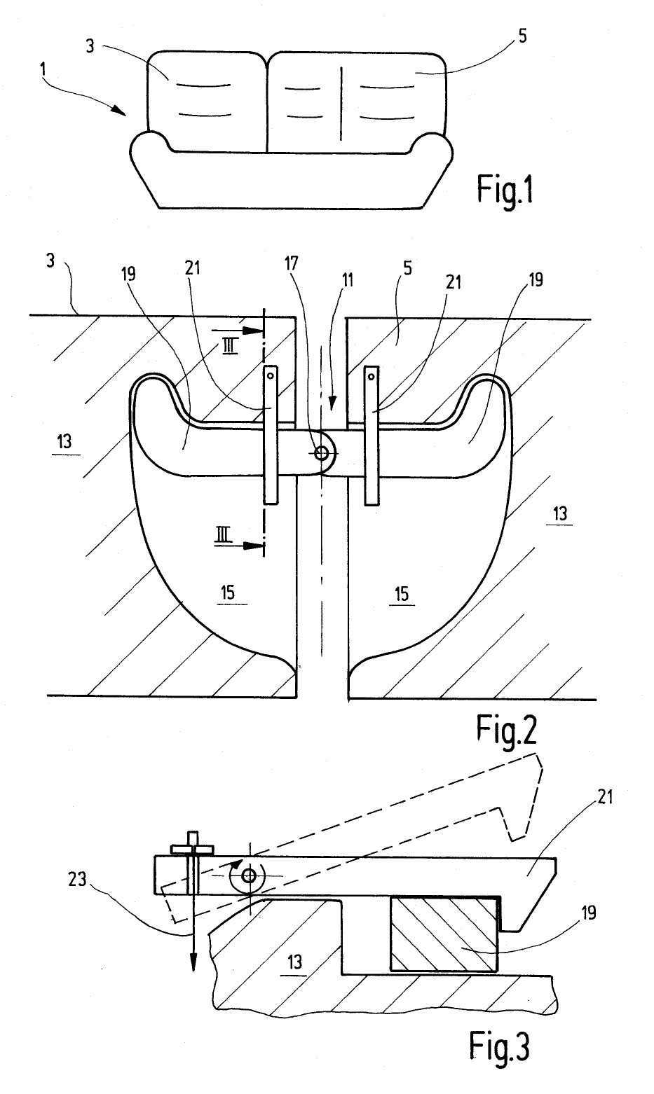

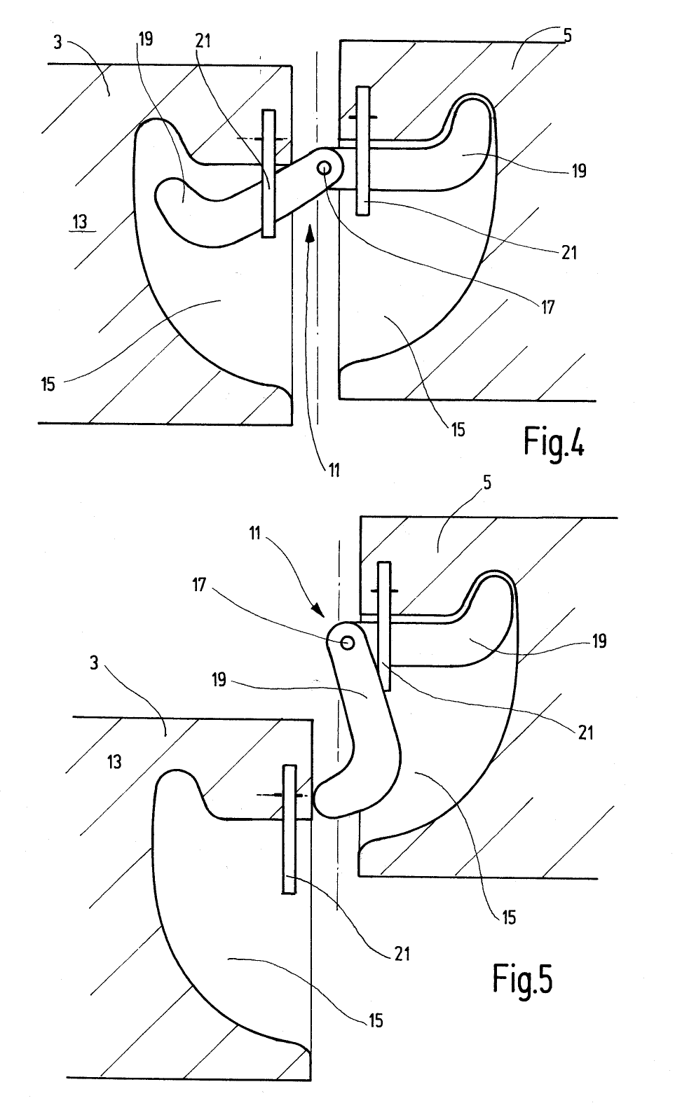

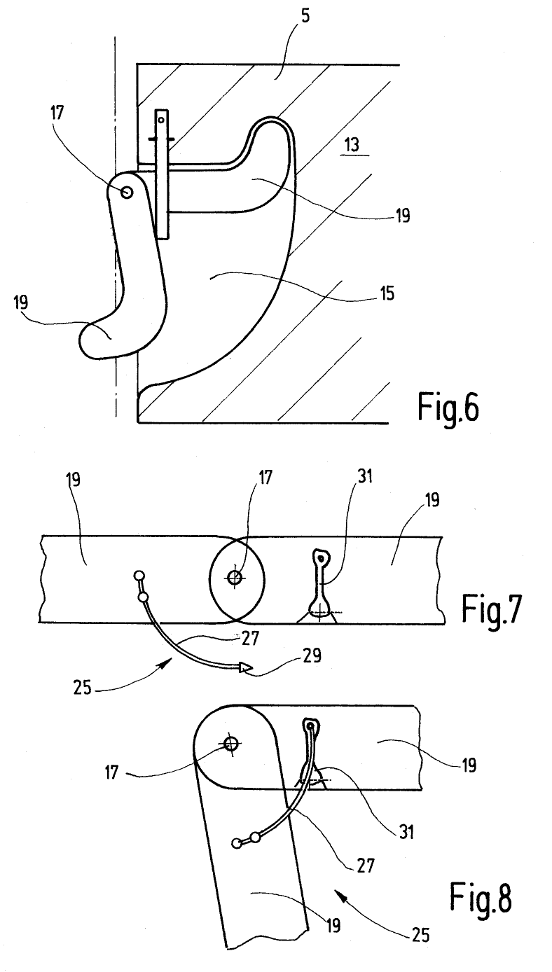

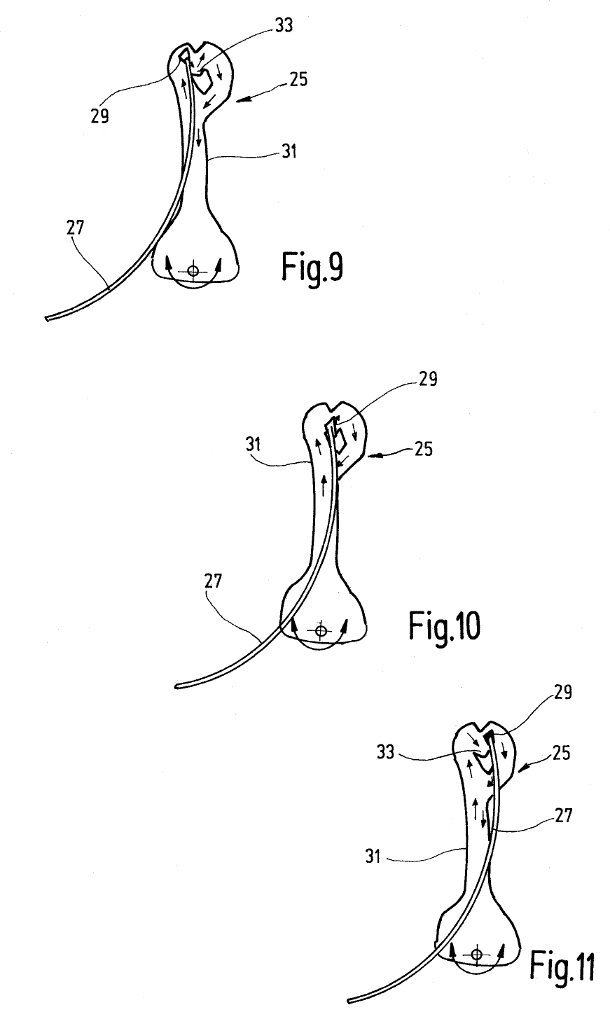

### DESCRIPTION OF THE PREFERRED EMBODIMENTS

Referring to the drawings in particular, a vehicle seat 1 for a row of rear seats in a motor vehicle comprises a split backrest consisting of a first backrest 3 accounting, for example, for one third of the overall width, and a second backrest 5 accounting, for example, for two thirds of the overall width. Both backrests 3 and 5 can be pivoted forwards from a locked in-use position in the direction of travel into a non-use position, after an unlocking mechanism has been actuated. A locking mechanism 11, provided and acting between the two backrests 3 and 5, is almost symmetrically constructed, so that either of the two backrests 3 and 5 can also be individually unlocked and pivoted forwards, as desired.

At each of the upper, mutually facing ends of the backrests 3 and 5 a recess 15 is formed in the backrest structure 13, which extends inwards into the backrest 3 or 5 respectively and remains open to the outside. The locking mechanism 11 comprises two connecting elements 19 which, in the present case, have a latch-like design and are connected to each other by a common joint 17. The pivoting axis defined by the joint 17 runs in the longitudinal direction of the backrest, following the orientation of the backrests 3 and 5 between their upper and the lower edges in the in-use position. When they are unlocked, the two connecting elements 19 are movably and in principle loosely arranged within the recess 15. In the in-use position, both connecting elements 19 are arranged in an extended configuration relative to each other, interacting with the respective backrest structure 13 through positive fit, and being both locked to the respective backrest structure by means of a locking element 21, which in the present case is in the shape of a hook. Each of the locking elements 21 is pivotably mounted on the backrest structure 13 of each of the backrests 3 and 5. The pivoting axes of the locking elements 21 are oriented in the horizontal transverse direction of the backrest, at right angles to the longitudinal direction of the backrest. The locking elements 21 could also be mounted in a linearly movable manner.

The locking mechanism 11 provided according to the invention comes into play if only one of the two backrests 3 and 5 is to be pivoted forward into the non-use position. Because of the almost symmetrical structure of the locking mechanism 11, there is no functional difference between the two possibilities of pivoting one of the backrests 3 and 5, which is why it is assumed that only the first backrest 3 is to be pivoted. Apart from a locking means provided on the side of the first backrest 3 facing away from the second backrest 5, the locking mechanism 11 on the side of the first backrest 3, which is to be pivoted, is also unlocked, and this is accomplished by using a Bowden cable 23 to actuate, i.e. unlock specifically the locking element 21 arranged on the first backrest 3, which is to be pivoted. Once this locking element 21 has released the associated connecting element 19, the latter can be swiveled within the recess 15, and the first backrest can be pivoted forward. When this happens, the backrest structure 13 of the pivoting first backrest 3, which forms the edge of the recess 15, pushes the connecting element 19 into the recess 15 of the unpivoted second backrest 5, so that both connecting elements 19 adopt a bent configuration.

The two connecting elements 19 are pretensioned against each other in the direction of the extended configuration by means of a leg spring, not shown here, arranged in the area of their common joint 17, and can be secured in the bent configuration by means of a detent mechanism 25. The detent mechanism 25 is based in the present case on the push-push principle (as in a ballpoint pen), but it may also be designed according to another principle. A leaf spring 27 carrying a triangular lug 29 is mounted on one of the connecting elements 19, while a guide 31, open on one side, for the lug 29 is arranged on the other connecting element 19, which, if necessary, may also be movable and in which there is provided a detent 33 for the lug 29 on a type of island structure. When the transition is made from the extended configuration to the bent configuration, the lug 29 enters the guide 31 and engages in the detent 33, where it forms a positive connection with the latter, thereby securing the bent configuration. When the two connecting elements 19 are in the bent configuration, this also prevents the locking element 21, which has remained locked, from being actuated.

When they are in the bent configuration, the connecting elements 19 are not completely arranged in the recess 15 of the unpivoted second backrest 5; instead, the connecting element 19, the larger part of which is swiveled into the recess 15 of the second backrest 5, still projects partially beyond the recess 15 of the connecting element 19, which has remained locked, and lies within the pivoting path of the pivoted first backrest 3. When the latter is pivoted from the non-use position back into the in-use position, its backrest structure 13 pushes the swiveled connecting element 19 slightly backwards. As a result, the lug 29 moves out of the detent 33 and moves outwards along the guide 31. The pretensioning of the connecting elements 19 relative to each other causes the swiveled connecting element 19 to swivel outwards again into the recess 15 of the first backrest 3, after the latter has been pivoted back into position, and to assume the extended configuration once more. Once the first backrest 3 has been pivoted back into its starting position, the locking element 21 locks the connecting element 19 which has been swiveled outwards. The first backrest 3 is at that point once more in the in-use position.

Pivoting of the second backrest 5 by itself is initiated in equivalent fashion by unlocking and pivoting the other connecting element 19.

While specific embodiments of the invention have been shown and described in detail to illustrate the application of the principles of the invention, it will be understood that the invention may be embodied otherwise without departing from such principles.

1. A vehicle seat comprising:
a first backrest;
a second backrest said first backrest and said second backrest being mounted for pivoting from an in-use position into a non-use position;
a locking mechanism for locking the two backrests together with each other in the in-use position, said locking mechanism comprising a connecting element that is locked with the second backrest when the first backrest is pivoted, and that is locked with the first backrest when the second backrest is pivoted.

2. A vehicle seat according to claim 1, wherein each of said first backrest and said second backrest comprise a recess for the connecting element on a respective mutually facing sides.

3. A vehicle seat according to claim 1, wherein said locking mechanism comprises a joint and another connecting element to provide two connecting elements linked together by means of said joint one of said two connecting elements being assigned to said first backrest and another of said two connecting elements being assigned to said second backrest.

4. A vehicle seat according to claim 3, wherein in the in-use position each of the two connecting elements cooperates and engages positively with the backrest structure of the respective associated backrest.

5. A vehicle seat according to claim 3, further comprising locking elements wherein in the in-use position each of the two connecting elements is locked in each case by means of one of said locking elements with the backrest structure of the respective associated backrest.

6. A vehicle seat according to claim 3, wherein in the in-use position the two connecting elements assume an extended configuration relative to each other.

7. A vehicle seat according to claim 3, wherein, in order to pivot one of said first backrest and said second backrest, the connecting element associated with the backrest that is to be pivoted is unlocked and is swiveled towards the other connecting element, so that the connecting elements assume a bent configuration relative to each other.

8. A vehicle seat according to claim 3, wherein in the non-use position the connecting element that is partially swiveled into the recess of the unpivoted backrest still partially projects into the pivoting path of the pivoted backrest.

9. A vehicle seat according to claim 8, wherein, when the first backrest is pivoted back, the pivoted backrest causes the swiveled connecting element projecting into pivoting path of said first backrest to swivel outwards again.

10. A vehicle seat according to claim 3, further comprising a detent mechanism wherein said detent mechanism, acting between the connecting elements, secures the bent configuration of the connecting elements.

11. A motor vehicle seat comprising:
a first backrest;
a second backrest, each of said first backrest and said second backrest being mounted for pivoting from an in-use position into a non-use position;
a connecting means for locking with said second backrest when said first backrest is pivoted into said non-use position and for locking with said first backrest when said second backrest is pivoted into said non-use position.

12. A motor vehicle seat according to claim 11, wherein:
said first backrest comprises a recess on a side facing said second backrest, said recess receiving said connecting means; and
said second backrest comprises a recess on a side facing said first backrest, said recess receiving said connecting means.

13. A motor vehicle seat according to claim 11, wherein said connecting means comprises a joint and a first connecting element and a second connecting element, said first connecting element and said second connecting element being linked together by said joint, said first connecting element being associated with said first backrest and said second connecting element being associated with said second backrest.

14. A motor vehicle seat according to claim 13, wherein:
said first connecting element extends into said recess of said first backrest and engages positively with said first backrest with said first backrest in said in-use position; and
said second connecting element extends into said recess of said second backrest and engages positively with a structure of said second backrest with said second backrest in said in-use position.

15. A motor vehicle seat according to claim 14, further comprising:
a first locking element locking said first connecting element in an engaged position with said first backrest;
a second locking element locking said second connecting element in an engaged position with said second backrest.

16. A motor vehicle seat according to claim 13, wherein in said in-use position said first connecting element extends away from said second connecting element.

17. A motor vehicle seat according to claim 13, wherein, in order to pivot one of said first backrest and said second backrest, the connecting element associated with the backrest that is to be pivoted is unlocked and is swiveled towards the other connecting element so that the connecting elements assume a bent configuration relative to each other.

18. A motor vehicle seat according to claim 13, wherein in the non-use position the connecting element that is swiveled into the recess of the unpivoted backrest still partially projects into the pivoting path of the pivoted backrest.

19. A motor vehicle seat according to claim 18, wherein, when one of said first backrest and said second backrest is pivoted back, the pivoted backrest causes the swiveled connecting element projecting into the pivoting path of the pivoted backrest to swivel outwards.

20. A motor vehicle seat according to claim 13, further comprising a detent mechanism wherein said detent mechanism, acting between the connecting elements, secures the bent configuration of the connecting elements.
